(19) United States
(12) Patent Application Publication
(10) Pub. No.: US 2007/0294843 A1
(43) Pub. Date: Dec. 27, 2007

(54) INTEGRAL OR SHAKE-ON COLORANT ADMIXTURE WITH IMPROVED COLOR DURABILITY IN CONCRETE AND OTHER CEMENTITIOUS SYSTEMS USING HIGHLY RESILIENT COLORANTS ORGANIC OR OXIDE IN NATURE

(76) Inventor: WILLIAM W. SUPPLEE, Hampton, NJ (US)

Correspondence Address: DUANE MORRIS LLP, PO BOX 5203, PRINCETON, NJ, 08543-5203, US

(21) Appl. No.: 11/760,421

(22) Filed: Jun. 8, 2007

Related U.S. Application Data
(60) Provisional application No. 60/816,089, filed on Jun. 23, 2006.

(51) Int. Cl. C03C 25/42

(52) U.S. Cl. 8/637.1; 8/636; 8/645

(57) ABSTRACT

Compositions and methods for coloring concrete and other cementitious systems having improved durability and retention of the colorant when integrally or surface shake applied to any concrete or other cementitious system. The compositions and methods include two phases of high grade dispersion in a combination of particulate polymers selected from particulated polymers, blends of polymers from styrene based polymers and copolymers, acrylic based polymers and copolymers, latex, poly vinyl acetates, polyepoxides, polyurethanes, and any of the family of liquid rubbers, including neoprene, butadiene, water based silanes, silicones, siloxanes, silicates, and any mixture and/or combination of the above. The compositions and methods include organic or oxide colorants.

### RELATED APPLICATION

This application claims the benefit of U.S. Provisional Application No. 60/816,089, filed Jun. 23, 2006, the entire disclosure of which is incorporated herein by reference.

### FIELD OF THE INVENTION

The invention relates to compositions and methods of preparing compositions for coloring concrete and other cementitious materials and systems.

### BACKGROUND

Highly resilient organic and oxide colorants are effective and durable in a variety of applications, such as paint systems for automobiles, houses and the like. These colorants are also used successfully in sophisticated combinations of compounds in the plastics and rubber industry.

An important reason that such colorants can be successfully used in these systems is that they represent completed systems at point of manufacture or application. In other words, the paint is applied as a completed system directly from the container and plastic and rubbers are extruded as a complete system into desired article. In these systems the ratio of the polymer formulation is many times the level of colorant being used. The extreme ratio of polymer to colorant provides the protection the colorant needs to endure exposure to mechanical wear, ultraviolet exposure, and biological degradation. More specifically, the monomers, polymers, copolymers, or emulsions form a protective barrier film for the pigment upon polymerization. The protective shield formed of the polymer hinders the effect of atmospheric degradation, known as weathering. Unless pigment particles are protected by the polymeric film the pigment particles are adversely affected causing color fading, degradation, and wash out of the colorants. This theory is applicable to films or coatings where the ratio of polymer to colorant in the product is sufficiently high to protect the colorant and is not subject to dilution at the point of application.

Such colorant or paint formulations applied as an integral colorant to concrete, however will fail relatively quickly due to dilution of the protective polymer in aqueous concrete systems. Specifically, colorant levels in concrete applications are maximized at 8% by weight of cement to avoid degrading the performance specifications of the concrete. Even polymer inclusions in concrete systems (see, for example, U.S. Pat. No. 3,650,784 to Albert) are limited to about a 30% maximum rate by weight of cement (as a dry component), to prevent degrading the performance specifications of the concrete. Liquid polymer inclusions are limited to much lower levels as they can negatively affect the slump or flow characteristics of the concrete system and interfere with normal hydration of the cement.

Colorant admixtures are added only as a percentage of the weight of cement. The bulk of a concrete system, however, is an aggregate of crushed stone and sand in ratio to a cement, specifically designed for a given concrete products application. In concrete roof tile manufacture, for example, the aggregate to cement ratio is generally around 3 parts aggregate to 1 part cement. In some high slump concretes, the aggregate to cement ratio may be as high as 10 parts aggregate to 1 part cement. When the colorant is added to such a system at 1% to 8% by weight of cement as an integral colorant, it is clearly apparent that the dilution of the protective polymer system will exceed levels that allow for protection of the colorant from ultraviolet, high alkalinity, and environmental exposure. Hence, the finished color of the concrete will degrade rapidly as the colorant is leached out of the system through normal environmental exposure.

Common concrete colorants are those specified in ASTM C979-86, Standard Specifications for Integrally Colored Concrete. The ASTM standards cover the basic requirements for colored and white pigments in the powder form to be used as admixtures in concrete to produce integrally colored concrete systems. The colorants listed in the ASTM specification are generally inorganic pigments, which can withstand the various physical and chemical effects of the intended use. These pigments are very limited relative to the range of colors they can produce, the colors comprising mostly dull earth tones. The pigments are tested according to the ASTM Specification for various properties including light fastness, water wetability, atmospheric curing stability, water solubility and the total sulfates. Typically, the pigments are inorganic mineral oxides such as synthetic or natural iron oxide, chromium green, and cobalt blues. The specification does not allow for the use of high tint strength high chroma organic colorants, as many of them in their unmodified state will not meet the ASTM Specification criteria. This severely limits the range of colors that can be produced in cementitious systems. These organic colorants achieve their intense coloration capabilities, to large extent, due to their extremely small particle size. For example, some carbon black colorants may be 100 times smaller than conventional iron oxide black pigments. This extremely small particle size along with the colorants hydrophobic nature makes it difficult to trap the pigments particles in the porous hydrated concrete matrix. Some other organic colorants are sensitive to alkalinity, others are sensitive to ultraviolet exposure making it difficult to provide a solution to fit all the requirements for inclusion in concrete systems.

Concretes containing polymers and organic and inorganic pigments as colorants, are known in the art. Although the initial color protection is improved over non-polymer modified concrete, the organic colorants degrade and leach from the system at a desirable rate.

Accordingly, colorant compositions and methods for making same are needed that incorporate the wide range of color possibilities that organic and resilient oxides may provide for concrete, i.e., a protective system that will allow highly resilient colorants to meet or exceed the requirements of ASTM 979-86, providing durable intensely colored cementitious systems.

### SUMMARY

A composition for coloring concrete and other cementitious materials and systems is described herein. In one embodiment, the composition comprises a colorant, a first polymer for encapsulating the colorant, and a second polymer for use in a dispersing the colorant encapsulated in the first polymer.

Also described herein is a method of making a composition for coloring concrete and other cementitious material and systems. In one embodiment, the method comprises forming a plurality of encapsulated colorant particles, the encapsulated colorant particles encapsulated in a first polymer, and dispersing the encapsulated colorant particles in a solution comprising a second polymer.

### BRIEF DESCRIPTION OF THE DRAWINGS

FIG. 1 is a flowchart illustrating an embodiment of a method for making a composition for coloring concrete and other cementitious materials and systems.

### DETAILED DESCRIPTION OF THE INVENTION

A composition is described herein for coloring concrete and other cementitious materials and systems. In one embodiment, the composition comprises a highly resilient colorant, an encapsulating polymer for encapsulating the colorant, and a dispersion polymer for use in dispersing the polymer encapsulated colorant for integral (the encapsulated colorant is mixed into the concrete mixture prior to forming) or surface shake-on (the encapsulated colorant is sprinkled onto the surface(s) of a recently formed uncured concrete slab or the like) application into a concrete and other cementitious material or system and aiding in trapping the colorant in the system matrix after curing and setting. The composition improves both the durability of the concrete and other cementitious material or system and provides the requited protection for durable performance of almost any colorant. More specifically, encapsulating the colorant first in a protective film similar to that used in paint systems and then dispersing the encapsulated colorant in additional protective polymer overcomes the dilution effect of the protective film in aqueous concrete and other cementitious materials and systems.

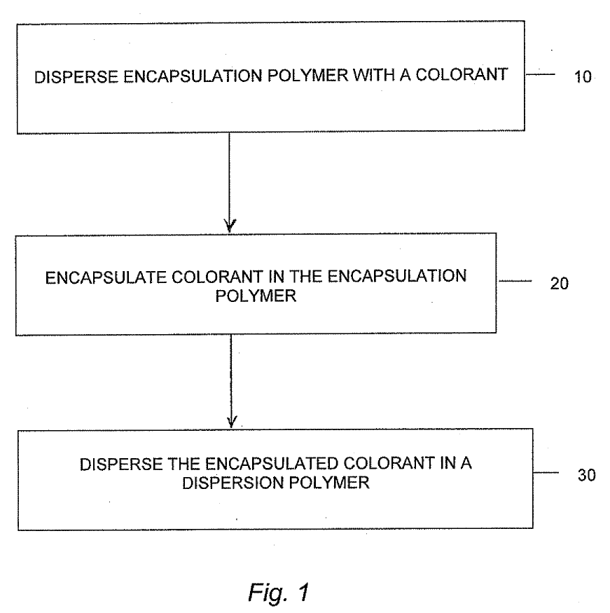

FIG. 1 is a flowchart illustrating an embodiment of a method for making the coloring composition. In step 10 of the method, the encapsulation polymer is dispersed with the colorant. In some embodiments, dispersion of the encapsulation polymer with the colorant may be performed in a high-speed dispersion apparatus similar to that used in manufacturing paint or any other suitable apparatus capable of dispersing the colorant with the encapsulation polymer. In one embodiment, step 10 includes a preliminary pH adjusting process where the pHs of the colorant and encapsulation polymer are individually adjusted prior to dispersion. The pH of the colorant may be adjusted between pH 9 and pH 10 and the pH of the encapsulation polymer may be adjusted between ph 4 and pH 5 in some embodiments. The pH adjustments increase the electrochemical attraction of the encapsulation polymer to the colorant e.g., pigment particles, improving the encapsulation efficiency of the process. The pH adjustment procedure may be performed by agitating the encapsulation polymer in an appropriate sized vessel, adjusting the pH of the encapsulation polymer to the target pH thereof, and then in a separate vessel adjusting the pH of the colorant, e.g., organic colorant, inorganic colorant, or blend of organic and inorganic colorant, to the target ph thereof. When both components have been pH adjusted, the colorant is slowly added to i.e., dispersed with the encapsulation polymer. The encapsulation polymer ph is monitored during dispersion to make sure it remains on the alkaline side of the pH scale. In some embodiments, the final pH target for the colorant/encapsulation polymer dispersion may be 7.5 to 9.5.

In step 20 of the method, the dispersion is processed to polymerize the encapsulation polymer so that it cannot be re-dispersed and encapsulate the colorant in the polymerized encapsulation polymer. In one embodiment, encapsulation may be performed by spray drying the dispersion through a spray dryer. In an alternate embodiment, encapsulation may be performed by processing the dispersion in a compaction press.

In step 30 of the method, the encapsulated colorant is dispersed with the dispersion polymer to complete the stabilization of the colorant for application in cementitious systems. In some embodiments, dispersion of the encapsulated colorant with the dispersion polymer may be performed in the earlier described high-speed dispersion apparatus or any other suitable apparatus capable of dispersing the encapsulated colorant with the dispersion polymer.

Encapsulating the colorant in a polymerized polymer prior to introduction to the cementitious system protects the colorant from the high alkaline environment of the cementitious system. In addition, the encapsulated colorant is water wet-able, insoluble, light-fast, and contains no sulfates. Encapsulation provides the increased particle size necessary for retention of the colorant in the porous concrete matrix with minimal loss of color tinting strength. Thus, the composition meets the requirements of the ASTM 979-86 Specification. The durability and stability of the encapsulated colorant is further enhanced by adding the encapsulated colorant to the dispersion polymer without dissolving the encapsulation polymer. The composition may then be added to any cementitious system. In some embodiments, the method may be repeated one or more times as required to protect more vulnerable colorants for cementitious systems.

Common concrete colorants preferred for use in the composition and method include, but are not limited to, the common established and acceptable colorants set forth in ASTM 979-86 Standard Specification for Integrally Colored Concrete. The common concrete colorants comprise inorganic mineral oxides and a concrete grade of carbon black, also referred to as common pigments. The acceptability of pigments for use in concrete structures is based upon scientific evidence of the ability to withstand various physical conditions and chemical reactions. The properties considered include light fastness, alkali resistance, water-wet ability, atmospheric curing stability, water solubility, and total sulfates. Currently, only inorganic mineral oxides and the above-noted carbon black are known to meet these criteria for concrete.

In addition to the common colorants, organic pigments, including all common black pigments and high chroma metallic pigments, may be used as colorants in the composition and method. The organic pigments are also referred to as uncommon pigments, because they are not generally used in the concrete industry for various reasons. The uncommon pigments which may be used as colorants in the composition and method include, but are not limited to, Zulu Blues, Zulu Greens, Sunglow Yellow, Citation Reds from Englehard and the Englehard line of Aurasperse aqueous dispersions. Other uncommon pigments which may be used as colorants in the composition and method include Fanchon Yellows, Palomar Greens, Palomar Blues, Indofast Violets, available from Bayer Corporation; Aurora Pink, Arc Yellow, and Saturn Yellow, available from Day-Glo Color Corporation of Cleveland, Ohio; carbon black pigment from Wolstenholme International, Inc.; Hans Yellow and Permanent Yellow available from Kingland Chemical Industrial Company of Hangzhou, China; and Phthalocyanine Blue, Phthalocyanine Green, Acrylide Yellow, Quinacridone Orange and Magenta available from Sun Chemical Corporation of Fort Lee, N.J.

Preferred uncommon pigments useable as colorants in the composition and method include Wet flake available from Huls; Aurasperse available from Englehard; Sunsperse available from Sun Chemical Corporation; Dry oxides and organics available from Bridge Chem in India, Kingland Chemical Industrial Company and Chemik Co., Ltd. in China and converted to liquid by Day-Glo Color Corporation and Crossfield Products Corporation and Carbon Black dispersions available from Wolstenholme International, Inc.

The quantity of the colorant used in the composition and method ranges between about 0.1% to about 80% by weight of the composition. In preferred embodiments, the colorant used in the composition and method ranges between about 5% and about 50% by weight of the composition. In more preferred embodiments, the colorant used in the composition and method ranges between about 30% and about 50% by weight of the composition, One of ordinary skill in the art will appreciate that the quantity of colorant used in the composition and method depends on the color desired in the intended end use.

The polymers used in the composition and method may include, but are not limited to, particulated polymers, blends of polymers from styrene based polymers and copolymers, methyl methacrylate polymers, methyl methacrylate copolymers, polyvinyl acetates, polyepoxides, polyurethanes, butadiene rubbers, water based silanes, silicones, siloxanes, silicates, and mixtures thereof. Examples of some preferred polymers include, but are not limited to, clear latex resin available from Sherwin Williams, Wallpol 40152-07 and Kelsol 4097 modified acrylic polyesters available from Reichold, Acronal 702, BASF 400 resins by modified styrene acrylics available from BASF, Reichold, Union Carbide, Dow, and styrene butadiene emulsions available from Dow under the tradename Dow 402. Examples of most preferred polymers include, but are not limited to, styrene acrylic, methyl methacrylate, butadiene, polymers and copolymers including Acronal 820 and 446 resins from Dow.

The polymers used in the composition and method may be provided as polymeric dispersions. Examples of polymeric dispersions include, but are not limited to, Ucar 820 emulsion and Kelso 305, which are both available from Dow Chemical.

The quantity of the encapsulation polymer used in the composition and method ranges between about 0.1% and about 85% by weight of the composition. In preferred embodiments, the encapsulation polymer used in the composition and method ranges between about 5% and about 50% by weight of the composition. In more preferred embodiments, the encapsulation polymer used in the composition and method ranges between about 10% and about 30% by weight of the composition. In some embodiments, the encapsulation polymer may be applied to re-dispersed dry organic pigments, re-dispersed oxide pigments, re-dispersed blends of dry organic and oxide pigments, dispersed wet flake of organic pigments, dispersed wet flake of oxide pigments, and dispersed wet flake of blends of dry organic and oxide pigments. In other embodiments, the encapsulation polymer may be applied to prepared dispersions of organic pigments, oxide pigments and blends of organic and oxide pigments.

The quantity of the dispersion polymer used in the composition and method ranges between about 1% and about 90% by weight of the total composition. In preferred embodiments, the quantity of the dispersion polymer used in the composition and method ranges between about 10% and bout 60% by weight of the total composition. In more preferred embodiments the quantity of the dispersion polymer used in the composition and method ranges between about 20% and about 50% by weight of the total composition.

The composition and method may also include one or more property enhancing additives including, but not limited to, plasticizers, surfactants, rheology modifiers, biological control agents and mixture thereof. The property enhancing additive or additives may be applied to the composition and method in quantities known to persons of ordinary skill in the art.

### EXAMPLES

### Example 1

In example 1, a predispersed Carbon Black solution (Carbon Black dispersion) from Wolstenholme International, Inc was used to supply a colorant. The Wolstenholme Carbon Black dispersion is made using a pretreatment process that makes the Carbon Black compatible with aqueous systems. Five gallons of the Wolstenholme Carbon Black dispersion were added to five gallons of Arolon 820 (polymer) in a high-speed cowls type disperset/mixer. The Arolon 820 is available from Union Carbide. Prior to dispersion, the pH of the Carbon Black solution was adjusted between pH 9 and pH 10, and the pH of the Arolon 820 was adjusted between pH 4 and pH 5. In addition, both components were adjusted to a solids content of approximately 40% prior to blending in the disperser/mixer. The materials were blended for approximately 15 minutes. The polymer/colorant dispersion was fed to a spray dryer at a rate that produced the smallest possible granules. The temperature of the spray dryer was set to the lowest possible temperature that would produce a finished granule in the 100 to 1000 micron particle diameter range and with a finished moisture content of no greater than 5%, and preferably in the 1% to 3% range. The temperature of the spray dryer typically ranges from about 60° C. to about 350° C., depending upon the color being prepared. The main objective of the spray drying phase (or compaction press phase) is to encapsulate the colorant particle in a non-soluble polymer film with minimal impact on color intensity. Table I below shows a color comparison between non-treated (not encapsulated in a polymer) colorants (the test controls) and the polymer modified colorant of Example 1. As can be seen from the data in Table I, the effect of the process described herein is minimal on color values.

TABLE I

| Sample I.D. | | | |
|---|---|---|---|
| Sample Age | Control Dry Organic | Control Iron Oxide | Example 1 |
| 1 Week | 1.4 | 0.2 | 0.4 |
| 4 Week | 5.4 | 0.6 | 0.9 |
| 2 Month | 15.8 Failed | 0.9 | 1.3 |
| 3 Month | Failed | 1.3 | 1.5 |
| 4 Month | Failed | 1.6 | 1.9 |
| 5 Month | Failed | 1.6 | 2.1 |
| 6 Month | Failed | 1.9 | 2 |
| 7 Month | Failed | 1.7 | 2.3 |
| 8 Month | Failed | 1.9 | 2.4 |
| 9 Month | Failed | 2.3 | 2.1 |
| 10 Month | Failed | 2.8 | 3 |
| 11 Month | Failed | 3.6 | 2.8 |
| 12 Month | Failed | 3.2 | 3.6 |

Color Measurement Cie Lab Delta E
Note:
Controls were a non-treated Dry Organic colorant and a non treated Iron oxide colorant.
Note:
0 to 2 Delta E is excellent performance, 2 to 4 is acceptable performance, 4 to 6 is marginal performance, and greater than 6 is failure.
Note:
Natural exposure was a 30 degree tilt southern exposure in New Jersey.

The encapsulated Carbon Black colorant was then added to a low intensity mixer containing five gallons of Dow Chemical 446 polymer solution (dispersion polymer) having a solids content set at 30%. The polymer encapsulated colorant may be added in the range of 5% to 40% depending on the intended final product use. In example 1, the encapsulated Carbon Black was dispersed with the Dow Chemical 446 at a level of 20% of the formula weight (i.e., pounds of encapsulated Carbon Black per gallon of Dow Chemical 446). The final mixture had a solids content of 50%. The material was stabilized with a sufficient quantity of Carboxy Methyl Cellulose (a thickener) to produce a viscosity of approximately 2000 cps on a Brookfield viscometer. To prevent biological contamination, 0.3% of Troysan 174 (biological control agent) was added to the formulation by weight.

### Example 2

Example 2 was the same as Example 1, except organic Thallo Blue dispersion available from Englehard Corporation was used as a colorant in place of Carbon Black. The Thallo Blue is a color match to dry cobalt blue oxide from China.

### Example 3

Example 3 was the same as Example 1, except a blend of Thallo Green and Yellow and Black Iron Oxide, available from Crossfield Products Corp., was used as a colorant in place of Carbon Black. The final color of this colorant is a match to Chromium Green Oxide from China.

### Example 4

Example 4 was the same as Example 1, except a high tint strength Black Iron Oxide composition was used as a colorant in place of Carbon Black and the final encapsulated black colorant was then used directly, without dispersing in the dispersion polymer, in high temperature roofing granule operation.

### Example 5

The colorant composition of Example 1 was incorporated in laboratory concrete units pressed in a laboratory 3″×5″ steel mold. In a Hobart laboratory mixer, one hundred grams of type I Portland cement was added and blended with 300 grams of typical concrete grade sand. An appropriate amount of water was added to produce a water to cement ratio of 0.3 to 0.4. The colorant composition of Example 1 was then added “as is” at a rate of 5% by weight of cement. The material was mixed to uniformity and then approximately 300 grams were transferred to a laboratory steel press and pressed at a pressure of 10,000 lbs. per square inch for 30 seconds. The completed units were then transformed to a 95% relative humidity oven set at 130 degrees Fahrenheit for 24 hours.

The above process was then repeated with dry untreated Carbon Black to produce a control. The process was then again repeated with Black Iron Oxide to provide a comparison to an ASTM 979-86 colorant comparison. Initial color measurements were taken on an ACS spectrophotometer to compare with color measurements taken after ageing. Two control samples from both applied compositions (one control concrete unit made with Carbon Black and one control concrete unit made with the colorant composition of Example 1) and the Dry Carbon control were placed in a dark humidity controlled environment for later comparison to environmentally aged samples. Although accelerated aging tests exist, i.e., Weather meter and Carbon Arc tests, natural environmental aging has been found to be the best aging test. To this end, the test samples were placed on an outdoor table or rack at a 36-degree angle facing south to provide intense summer sun, spring rains, and winter freezing thawing and snow. The samples were aged and periodically brought back into the laboratory where they were rinsed with distilled water to remove deposited dirt and migrated salts as such materials may interfere with accurate color retention measurements. The concrete samples were measured with a colorimeter and the aged data was compared with the initial color measurements.

Table I above shows the result of one year of natural environmental aging. When compared to the control, which lost nearly all of its initial color value, the samples using the colorant composition disclosed herein clearly demonstrate the desired improvement of these compositions. When compared to the ASTM 979-86 iron Oxide Black, the compositions and methods disclosed herein also demonstrate the ability to meet the ASTM certification.

### Example 6

Example 6 was the same as Example 5 except, the colorant composition of Example 2 was used in place of the colorant composition of Example 1. Dry Organic Blue and Cobalt Blue Oxide were used as controls. The aging data of Example 6 is presented in Table II below.

TABLE II
Blue Colorant

| Sample I.D. | | Control Cobalt | |
|---|---|---|---|
| Sample Age | Control Dry Organic | Oxide | Example 6 |
| 1 Week | 0.9 | 0.0 | 0.2 |
| 4 Week | 6.8 | 0.6 | 0.9 |
| 2 Month | 23.5 Failed | 0.6 | 1.1 |
| 3 Month | Failed | 0.6 | 1.5 |
| 4 Month | Failed | 1.1 | 1.4 |
| 5 Month | Failed | 1.2 | 1.6 |
| 6 Month | Failed | 1.9 | 1.6 |
| 7 Month | Failed | 2.2 | 2.3 |
| 8 Month | Failed | 2.6 | 2.4 |
| 9 Month | Failed | 3.1 | 3.4 |
| 10 Month | Failed | 3.6 | 3.0 |
| 11 Month | Failed | 3.6 | 2.8 |
| 12 Month | Failed | 3.3 | 3.8 |

Color Measurement Cie Lab Delta E
Note:
Controls were a non-treated Dry Organiccolorant and a non-treated Cobalt Oxide colorant.
Note:
0 to 2 Delta E is excellent performance, 2 to 4 is acceptable performance, 4 to 6 is marginal performance, and greater than 6 is failure.
Note:
Natural Exposure was a 30 degree tilt southern exposure in New Jersey.
Note:
Color Measurements comprised an average of 9 shots on an ACS Colorimeter.

### Example 7

Example 7 was the same as Example 5 except, the colorant composition of Example 3 was used in place of the colorant composition of Example 1. Dry organic untreated Green and Chromium Green Oxide were used as controls. The data following aging is presented in Table III below.

TABLE III
Green Colorant

| Sample I.D. | | Control Chrome | |
|---|---|---|---|
| Sample Age | Control Dry Organic | Green | Example 7 |
| 1 Week | 0.4 | 0.2 | 0.1 |
| 4 Week | 0.4 | 0.6 | 0.2 |
| 2 Month | 1.1 | 1.0 | 1.1 |
| 3 Month | 1.4 | 0.6 | 1.0 |
| 4 Month | 2.6 | 1.1 | 0.9 |
| 5 Month | 5.5 | 1.8 | 1.2 |
| 6 Month | 7.9 | 2.6 | 1.6 |
| 7 Month | Failed | 3.8 | 1.9 |
| 8 Month | Failed | 4.4 | 2.1 |
| 9 Month | Failed | 4.2 | 2.0 |
| 10 Month | Failed | 5.4 | 2.2 |
| 11 Month | Failed | 6.1 | 2.1 |
| 12 Month | Failed | 7.6 | 2.4 |

Color Measurement Cie Lab Delta E
Note:
Controls were a non-treated Dry Organic colorant and a non-treated Chromium Green Oxide colorant.
Note:
0 to 2 Delta E is excellent performance, 2 to 4 is acceptable performance, 4 to 6 is marginal performance, and greater than 6 is failure.
Note:
Natural Exposure was a 30 degrees tilt southern exposure in New Jersey.
Note:
Color Measurements comprised an average of 9 shots on an ACS Colorimeter.
Note:
China produced Chrome Green contains unstable Iron green.

### Example 8

Example 8 was an actual field test of the colorant composition of Examples 1 and 3 at a roof tile facility. Samples of the facility's standard Iron Oxide produced roof tile using both Black Iron Oxide and Chromium Oxide Green were produced as controls. Samples of the colorant compositions of Examples 1 and 2 were downloaded (i.e., reduced weights of the compositions were applied to the cement samples to yield equivalent colors) significantly due to their color intensity at a level that would produce a cost effective color match to the controls. The roof tile samples made with the controls and the colorant compositions were aged on an aging facility or rack and the results of these tests are presented in Table IV below.

TABLE IV

| | | | | | High Tint | | | | | | | |
|---|---|---|---|---|---|---|---|---|---|---|---|---|
| | | | | | Comparative | | | | | | High Tint | |
| | Dry Organic | | Example | | Chrome | | Example | | Dry Organic | | Chinese | |
| Sample I.D. | Green | | 3 | | Green | | 1 | | Black | | Iron Black | |
| Sample Age | DE | Tint | DE | Tint | DE | Tint | DE | Tint | DE | Tint | DE | Tint |
| 1 Week | 0.2 | 98 | 0.1 | 102 | 0.5 | 97 | 0.1 | 104 | 2.6 | 94 | 0.9 | 98 |
| 4 Week | 2.6 | 91 | 0.3 | 104 | 0.8 | 95 | 0.1 | 102 | 4.8 | 85 | 1.2 | 97 |
| 2 Month | 4.8 | 86 | 0.5 | 101 | 1.4 | 90 | 0.1 | 100 | 10.7 | 62 | 1.7 | 92 |

| | | | | | | | | | | | |
|---|---|---|---|---|---|---|---|---|---|---|---|
| 3 Month | 9.6 | 78 | 0.8 | 98 | 2.4 | 86 | 0.8 | 96 | Failed | 2.3 | 88 |

| | | | | | | | | | | |
|---|---|---|---|---|---|---|---|---|---|---|
| 4 Month | Failed | 1.1 | 96 | 3.2 | 81 | 1.2 | 94 | Failed | 2.9 | 77 |
| 5 Month | Failed | 1.4 | 96 | 2.8 | 84 | 1.6 | 92 | Failed | 3.5 | 72 |
| 6 Month | Failed | 1.2 | 96 | 3.3 | 82 | 1.6 | 93 | Failed | 4.6 | 67 |
| 7 Month | Failed | 2.2 | 92 | 3.8 | 78 | 2.0 | 90 | Failed | 5.8 | 62 |
| 8 Month | Failed | 2.5 | 90 | 3.6 | 80 | 1.8 | 92 | Failed | 6.8 | 64 |
| 9 Month | Failed | 2.3 | 91 | 3.6 | 84 | 2.3 | 88 | Failed | 10.7 | 52 |

| | | | | | | | | | |
|---|---|---|---|---|---|---|---|---|---|
| 10 Month | Failed | 2.8 | 93 | 3.8 | 81 | 2.6 | 88 | Failed | Failed |
| 11 Month | Failed | 2.7 | 91 | 4.0 | 78 | 2.8 | 86 | Failed | Failed |
| 12 Month | Failed | 2.7 | 90 | 4.1 | 76 | 3.6 | 83 | Failed | Failed |

Color Measurement FMCII Delta E and Tint Strength
Note:
Controls were non-treated Dry Organic oxide colorants..
Note:
0 to 2 Delta E is excellent performance, 2 to 4 is acceptable performance, 4 to 6 is marginal performance, and greater than 6 is failure.
Note:
Natural exposure was a 30 degree tilt southern exposure in New Jersey.
Note:
Failure of common pigment Chinese black is noteworthy, as this pigment has the highest strength of all the available black pigments, but a very high fraction of unstable ultra small particles in thePSD (particle size distribution). A large fraction of the tint strength originates from unstable ultra small particles. The unstable ultra small particles are unstable in high alkaline applications thereby resulting in excessive loss of tint strength in such applications.

### Example 9

In Example 9, the colorant compositions of Examples 2 and 3 were field tested at a paver producer. Control and colorant composition samples were produced on a Tiger equipment board machine. Samples of untreated Thallo Green dispersion standard, represent the control for the colorant composition of Example 3 and a dry Thallo Blue standard represents the control for the colorant composition of Example 2. The colorant compositions of Examples 2 and 3 were loaded at 3%, “as is” on a cement weight basis in white cement for optimal color presentation. The control and colorant composition samples were aged and color measurements were periodically taken and compared to stored controls on an ACS Spectrophotometer to demonstrate color retention or loss. The results of these tests are presented in Table V below.

TABLE V

| | Dry Organic | | | | Dry Organic | | | |
|---|---|---|---|---|---|---|---|---|
| Sample I.D. | Dispersion | | Example 3 | | Blue | | Example 2 | |
| Sample Age | DE | Tint | DE | Tint | DE | Tint | DE | Tint |
| 1 Week | 0.1 | 99 | 0.2 | 104 | 3.4 | 94 | 0.1 | 102 |
| 4 Week | 0.3 | 98 | 0.3 | 103 | 5.5 | 85 | 0.1 | 102 |

| | | | | | | | |
|---|---|---|---|---|---|---|---|
| 2 Month | 0.8 | 95 | 0.5 | 101 | Failed | 0.1 | 99 |
| 3 Month | 1.2 | 92 | 0.8 | 99 | Failed | 0.8 | 98 |
| 4 Month | 1.5 | 93 | 1.1 | 99 | Failed | 0.5 | 97 |
| 5 Month | 2.2 | 83 | 1.3 | 99 | Failed | 1.2 | 95 |
| 6 Month | 2.5 | 86 | 1.2 | 98 | Failed | 1.6 | 93 |
| 7 Month | 3.3 | 83 | 2.2 | 96 | Failed | 1.4 | 94 |
| 8 Month | 3.6 | 86 | 2.3 | 97 | Failed | 1.8 | 92 |
| 9 Month | 5.5 | 82 | 2.6 | 94 | Failed | 2.0 | 90 |

| | | | | | | |
|---|---|---|---|---|---|---|
| 10 Month | Failed | 2.8 | 98 | Failed | 1.8 | 92 |
| 11 Month | Failed | 2.7 | 94 | Failed | 2.4 | 89 |
| 12 Month | Failed | 2.7 | 94 | Failed | 2.8 | 88 |

Color Measurement FMCII Delta E and Tint Strength
Note:
Rate of color loss varies with seasons.
Note:
0 to 2 Delta E is excellent performance, 3 to 4 is acceptable performance, 4 to 6 is marginal performance, and greater than 6 is failure.
Note
Natural exposure was a 30 degree tilt southern exposure in New Jersey.

### Example 10

In Example 10, the colorant composition of Example 4 was used in a laboratory scale trial. Roofing granule operations typically use Magnesium Ferrite as a black colorant because this material is stable at the elevated temperatures associated with autoclaved cementitious products. Iron oxide has been shown to be unstable at these temperatures demonstrating severe color loss in the roofing granule process. Using the standard Magnesium Ferrite black colorant in one experiment and the colorant composition of Example 4 as another test, the two materials generated control samples as well as test samples that could be aged in a laboratory oven at 350 degrees Fahrenheit. Color measurements were taken on an ACS Spectrophotometer for a period of one-week continuous exposure to the temperature.

The results of these tests are a subjective visual color evaluation. The surface of the completed test product does not allow for color difference measurements. In the visual evaluation, no distinct difference was noticeable between the invention sample and the control sample.

### Example 11

In Example 11, the colorant of Example 2 was used as a shake on or swirl colorant for a colored stamped concrete finish. The concrete was poured in place in a high slump condition. The colorant was shaken over the surface or swirled into the surface to produce a mottled effect. This test represents an actual field trial of the colorant composition of Example 2. For measurement purposes and because the test involved an actual driveway, a hand held spectrophotometer was used to measure difference after six months. The results of six months of aging are presented in Table VI below.

TABLE VI

| | |
|---|---|
| | Color |
| Blue Swirl Driveway | Measurement |

| Sample Age | DE | Tint |
|---|---|---|
| Initial Measurement | 0.1 | 102 |
| 6 Month | 0.4 | 96 |

Color Measurement Cie Lab Delta E
Note:
Control was a non-treated Dry Organic Cobalt Oxide colorant.
Note:
0 to 2 Delta E is excellent performance, 2 to 4 is acceptable performance, 4 to 6 is marginal performance, and greater than 6 is failure.
Note:
Natural exposure was a 30 degree tilt southern exposure in New Jersey.
Note:
Color Measurements comprised an average of 9 shots on Portable Minolta Meter.

### Example 12

In Example 12, a predispersed Carbon Black dispersion from Wohlstemholm International, Inc was used to supply a colorant (as in Example 1). Five gallons of the Wohlstenholm Carbon Black dispersion were added to five gallons of Polymer 446 (available from Union Carbide) in a high-speed cowls type disperser/mixer. Both of these components were adjusted to approximately 20% solids content prior to being blended in the disperser/mixer. The materials were blended for approximately 15 minutes. The Carbon Black colorant was electrochemically encapsulated in the polymer via the pH adjustment process described in Example 1 but was not dried after encapsulation. The electrochemically encapsulated colorant was then added to a low intensity mixer containing five gallons of Dow 446 polymer solution and adjusted to a solids content of 10%, and then blended at a ratio of 1:1 with Tegosivin HL 250 (available from Goldschmidt Industrial Specialties) and adjusted to a solids content of 10%. The final colorant composition may be added to cementitious systems in the range of 5% to 40% (by weight) depending upon the intended use of the system. In Example 12, the predispersed Carbon Black (polymer encapsulated Carbon Black) is added back into the Dow 446 to a level of 20% of the formula weight. The solids content of the final mixture was then adjusted to 30%, by adding water to the based colorant and polymer system, i.e., 20% dry encapsulated colorant in 40% active polymer, to reduce the final solids content to 30%. The mixture was stabilized with a quantity of Carboxy Methyl Cellulose sufficient to produce a viscosity of approximately 2000 cps on Brookfield viscometer. Finally, 0.3% of Troysan 174 was added to the formulation by weight to prevent biological contamination.

### Example 13

The material produced in example 12 is incorporated in laboratory concrete units pressed in a laboratory 3″×5″ steel mold. Into a Hobart laboratory mixer one hundred grams of type one Portland cement are added and blended with 300 grams of typical concrete grade sand. The appropriate amount of water is added to produce a water to cement ratio of 0.3 to 0.4. The finished colorant invention is then added at a rate of 5% by weight of cement as is. The material is mixed to uniformity and then approximately 75 gms are transferred to the laboratory steel press and pressed at a pressure of 10,000 lbs per square inch for 30 seconds. The completed units are then transformed to a 95% relative humidity oven at 130 degrees Fahrenheit for 24 hours. The above process is then repeated with dry untreated carbon black to produce a control study. The process is then again repeated with black iron oxide to provide a comparison to an ASTM 979-86 colorant comparison. Initial color measurements are taken on an ACS spectrophotometer to compare with aged samples. Two control samples from both the applied invention and the dry carbon control are then placed in a dark humidity controlled environment for later comparison to environmentally aged samples. Although accelerated ageing tests exist as both Weather meter and Carbon Arc tests it is our experience that natural environmental ageing is best. The test samples are placed on an outdoor table or rack at a 30-degree angle facing South. At our NJ facility this means intense sun in summer, rains of spring, and freeze thaw and snow in winter. A good well rounded testing environment. The samples are aged and periodically brought back into the laboratory. They are rinsed with distilled water to remove deposited dirt and migrated salts as they materials can interfere with accurate color retention measurements. The concrete samples are measured with the calorimeter and the aged data is then compared with the initial color measurements.

Table VII shows the result of 6 months of natural environmental ageing. It can be clearly seen the effect of the applied invention. When compared to the control, which has lost nearly all of its initial color value, the invention clearly demonstrates the desired improvement of the invention. When compared to the ASTM 979-86 iron oxide black the invention also demonstrates the ability to meet the ASTM certification.

TABLE VII

| Sample I.D. | | | |
|---|---|---|---|
| Sample Age | Control Dry Organic | Control Iron Oxide | Example 13 |
| 1 Week | 2.6 | 0.2 | 0.2 |
| 4 Week | 6.4 | 0.5 | 0.4 |
| 2 Month | 18.3 | 0.9 | 0.4 |
| 3 Month | Failed | 1.0 | 0.6 |
| 4 Month | Failed | 1.6 | 0.4 |
| 5 Month | Failed | 1.8 | 0.8 |
| 6 Month | Failed | 1.9 | 1.2 |
| 7 Month | Failed | 1.7 | 1.6 |
| 8 Month | Failed | 1.9 | 1.4 |
| 9 Month | Failed | 2.6 | 1.6 |
| 10 Month | Failed | 3.2 | 1.9 |
| 11 Month | Failed | 3.6 | 2.2 |
| 12 Month | Failed | 4.4 | 2.3 |

Color Measurement Cie Lab Delta E
Note:
Control to Example 13 is Dry Organic Iron Oxide colorant.
Note:
0 to 2 Delta E excellent performance, 2 to 4 is acceptable performance, 4 to 6 is marginal performance, and greater than 6 is failure.
Note
Natural exposure was a 30 degree tilt southern exposure in New Jersey.

### RESULTS AND DISCUSSION

It can be clearly seen from the above examples and data that the compositions and methods disclosed herein provide improved color retention of highly resilient organic, mineral oxide, mixed metallic oxides colorants in cementitious systems. The data for the aged samples of the composition, when compared to conventional iron oxide, chromium green, and cobalt blue, clearly shows equivalent or better performance than the ASTM 979-86 approved colorants. It should be noted that the ASTM color difference after aging is a subjective visual evaluation. In all the aging experiments conducted, there were no samples that did not show a visual color difference (i.e., all the samples showed a color difference including the ASTM 979-86 approved colorants). Visual color difference is a failure according to the specification. Therefore, actual color measurements were chosen as the criteria for passing or failing The compositions and methods described herein now broaden the spectrum of colorants and colors available to a variety of cementitious systems previously limited to the earth tones colors provided by simple iron oxide colorants. The compositions and methods described herein broaden the field of colorants now available to architects in the design of any concrete or cementitious system. In addition, the compositions and method described herein may provide improved performance of mineral oxides in multiple cementitious applications including those exposed to high temperatures during manufacture.

While the foregoing invention has been described with reference to the above, various modifications and changes can be made without departing from the spirit of the invention. Accordingly, all such modifications and changes are considered to be within the scope of the appended claims.

What is claimed is:

1. A composition for coloring concrete and other cementitious materials and systems, comprising:
a colorant; and
a first polymer for encapsulating the colorant.

2. The composition according to claim 1, further comprising a second polymer for use in a dispersing the colorant encapsulated in the first polymer.

3. The composition according to claim 2, wherein the first and second polymers are each selected from the group consisting of particulated polymers, blends of polymers from styrene based polymers and copolymers, methyl methacrylate polymers, methyl methacrylate copolymers, polyvinyl acetates, polyepoxides, polyurethanes, butadiene rubbers, water based silanes, silicones, siloxanes, silicates, and mixtures thereof.

4. The composition according to claim 1, wherein the colorant comprises a pigment established under ASTM C979-86, Standard Specification for Integrally Colored Concrete.

5. The composition according to claim 1, wherein the colorant comprises a mineral oxide.

6. The composition according to claim 1, wherein the colorant comprises carbon black.

7. The composition according to claim 1, wherein the colorant comprises a pigment selected from the group consisting of organic pigments, black pigments, and high chroma metallic pigments.

8. The composition according to claim 1, further comprising a property modifying additive selected from the group consisting of plasticizers, surfactants, rheology modifiers, biological control agents and combinations thereof.

9. The composition according to claim 1, wherein the colorant comprises a dry pigment.

10. The composition according to claim 1, wherein the colorant comprises a pre-dispersed pigment.

11. The composition according to claim 1, wherein the colorant comprises about 0.1 percent by weight to about 80.0 percent by weight of the composition.

12. The composition according to claim 1, wherein the first polymer comprises about 5.0 percent by weight to about 60.0 percent by weight of the composition.

13. The composition according to claim 2, wherein the second polymer comprises about 5.0 percent by weight to about 60.0 percent by weight of the composition.

14. The composition according to claim 1, wherein the colorant encapsulated in the first polymer comprises about 0.1 percent by weight to about 90.0 percent by weight of the composition.

15. A method of making a composition for coloring concrete and other cementitious materials and systems, the method comprising the steps of:
providing colorant particles; and
encapsulating the colorant particles in a first polymer.

16. The method according to clam 15, further comprising the step of dispersing the encapsulated colorant particles in a solution comprising a second polymer.

17. The method according to claim 15, wherein the encapsulating step comprises the step of forming a dispersion comprising the first polymer and the colorant particles.

18. The method according to claim 17, wherein the encapsulating step further comprises the step of spray drying the dispersion.

19. The method according to claim 17, wherein the encapsulating step further comprises the step of dry pressing the dispersion.

20. The method according to claim 16, wherein the first and second polymers are each selected from the group consisting of particulated polymers, blends of polymers from styrene based polymers and copolymers, methyl methacrylate polymers, methyl methacrylate copolymers, polyvinyl acetates, polyepoxides, polyurethanes, butadiene rubbers, water based silanes, silicones, siloxanes, silicates, and mixtures thereof.

21. The method according to claim 15, wherein the colorant particles comprise a pigment established under ASTM C979-86, Standard Specification for Integrally Colored Concrete.

22. The method according to claim 15, wherein the colorant particles comprise a mineral oxide.

23. The method according to claim 15, wherein the colorant particles comprise carbon black.

24. The method according to claim 15, wherein the colorant particles comprise a pigment selected from the group consisting of organic pigments, black pigments, and high chroma metallic pigments.

25. The method according to claim 15, further comprising the step of adding a property enhancing additive to the solution, the property enhancing additive selected from the group consisting of plasticizers, surfactants, rheology modifiers, biological control agents and combinations thereof.

26. The method according to claim 15, wherein colorant particles comprise a dry pigment.

27. The method according to claim 15, wherein the colorant particles comprise a pre-dispersed pigment.

28. The method according to claim 15, wherein the colorant particles comprise about 0.1 percent by weight to about 80.0 percent by weight.

29. The method according to claim 15, wherein the first polymer comprises about 5.0 percent by weight to about 60.0 percent by weight of the composition.

30. The method according to claim 16, wherein the second polymer comprises about 5.0 percent by weight to about 60.0 percent by weight of the composition.

31. The method according to claim 15, wherein the encapsulated colorant particles comprise about 0.1 percent by weight to about 90.0 percent by weight.

32. A method of making a composition for coloring concrete and other cementitious materials and systems, the method comprising the steps of:
forming a first dispersion comprising a plurality of colorant particles and a first polymer; and
drying the dispersion to encapsulate the plurality of colorant particles in the first polymer.

33. The method according to claim 32, further comprising the step of forming a second dispersion comprising the first polymer encapsulated colorant particles and a second polymer.

34. A method for coloring concrete and other cementitious materials and systems, the method comprising the steps of:
providing a composition comprising a colorant encapsulated by a first polymer; and
applying the composition to the material or system.

35. The method according to claim 34, wherein the step of applying the composition to the material or system is performed by mixing the composition into the material or system prior to its use in forming a slab or other structure.

36. The method according to claim 34, wherein the step of applying the composition to the system is performed by sprinkling the composition onto a surface of an uncured slab or other structure made of the material or system.
